(19) United States
(12) Patent Application Publication
(10) Pub. No.: US 2006/0099436 A1
(43) Pub. Date: May 11, 2006

(54) Reduced antifog level in oxygen scavenging film with antifog properties

(75) Inventors: Dwight Wayne Schwark, Simpsonville, SC (US); Drew Ve Speer, Simpsonville, SC (US)

Correspondence Address: Sealed Air Corporation, P.O. Box 464, Duncan, SC, 29334, US

(73) Assignee: Cryovac, Inc.

(21) Appl. No.: 10/982,458

(22) Filed: Nov. 5, 2004

(51) Int. Cl. B32B 27/08; B32B 27/34; B32B 27/36; B32B 27/30; B32B 27/32

(52) U.S. Cl. 428/474.4; 428/522; 428/523; 428/910; 428/480

(57) ABSTRACT

A multilayer film includes a first and second outer layer each including a polymer; and an internal layer including an oxygen scavenger; where the first outer layer includes a blend of a polymer and an antifog agent, where the antifog agent includes at least one of a mono fatty acid derivative of glycerol, and a polyglycerol mono fatty acid derivative; and wherein the first outer layer includes from 0.1% to 3%, by weight of the first outer layer, of the antifog agent.

### FIELD OF THE INVENTION

The invention relates to an oxygen scavenging film with antifog properties.

### BACKGROUND OF THE INVENTION

It is known that many oxygen sensitive products, including food products such as meat and cheese, smoked and processed luncheon meats, as well as non-food products such as electronic components, pharmaceuticals, and medical products, deteriorate in the presence of oxygen. Both the color and the flavor of foods can be adversely affected. The oxidation of lipids within the food product can result in the development of rancidity. These products benefit from the use of oxygen scavengers in their packaging.

Some of these oxygen scavengers, typically unsaturated polymers with a transition metal catalyst, can be triggered or activated by actinic radiation. Such materials offer the advantage of an oxygen scavenger that does not prematurely scavenge oxygen until such time as the user decides to use the oxygen scavenger in a commercial packaging environment. The oxygen scavenger is thus “dormant” until it is passed through a triggering unit, typically a bank of UV lights through which an oxygen scavenger in the form of a film is passed to trigger the oxygen scavenging activity of the material. This is usually done just prior to a packaging step, in which a package having as a component the oxygen scavenger is made, with an oxygen sensitive product placed in the package prior to closure of the package to extend the shelf life of the oxygen sensitive product.

Also, packaging films often require antifog properties in order to provide a final packaged product without excessive moisture buildup on the interior surface of the package. Packaging films typically require antifog properties for packaging certain types of food products. End use applications include refrigerated MAP lidding applications such as trays, semi-rigid containers and case-ready packaging.

It has been found that an antifog agent may be incorporated into the sealant layer on one side of an oxygen scavenging film, adjacent to the oxygen scavenging layer, to yield antifog performance often superior to that of conventional, non oxygen scavenging antifog films, while often actually enhancing oxygen scavenging performance. In addition, heat seal and lamination of the oxygen scavenging antifog film are not significantly impacted by the presence of the antifog agent. This result was discovered even given that similar incorporation of amide wax slip agents in oxygen scavenging films at levels several times less than antifog agent levels are seen to significantly degrade oxygen scavenging, lamination, and heat seal performance.

It has been found that antifog agent in a single sealant layer adjacent to the oxygen scavenging layer is able to bloom to the surface and provide superior antifog properties compared to a conventional, symmetric antifog film which has two sealant layers each containing the same antifog agent present in the sealant layer of the oxygen scavenging antifog film. Also surprising is the fact that no significant migratory additive-induced degradation of oxygen scavenging performance is observed with oxygen scavenging antifog films of the present invention. In contrast, ten times lower concentrations of other migratory film additives, such as erucamide, have been found to significantly and undesirably decrease oxygen scavenging rate.

Typical antifog films employ a symmetric film structure with antifog agent present in both outer surface layers of the film. The symmetric film structure is employed both because of simplicity in extrusion of the film and also because two opposing layers of antifog agent minimize loss of the antifog agent from the surface layer into the core of the film. While such a symmetric, dual antifog layer film has advantages, there are also numerous disadvantages. As with slip agents, antifog agents are known to degrade heat seal and lamination bond strength, as well as ink adhesion. These limitations are present for a film that typically requires antifog performance on only one side of the film. Thus, one advantage of the invention lies in the ability to generate an antifog film that has superior antifog properties to the conventional dual antifog layer films, with antifog only on the surface of interest, and without significantly degrading other film properties. In the case of the present invention, the advantages are improved oxygen scavenging performance and the ability to laminate and heat seal the film. While the process of applying a surface coating to one side of the film can yield antifog properties, there are numerous manufacturing and environmental costs associated with this process. Hence, the use of a migratory antifog agent within a single extruded surface layer provides numerous manufacturing and performance benefits.

### DEFINITIONS

“Antifog agent” and the like herein means or refers to an additive that prevents or reduces the condensation of fine droplets of water on a surface of a packaging film. Such additives function as mild wetting agents that exude to the surface of the packaging film, and lower the surface tension of the water, thereby causing the water to spread into a continuous film. Examples of antifog agents are a mono fatty acid derivative of glycerol (e.g. glycerol monostearate), and a polyglycerol mono fatty acid derivative (e.g. polyglycerol monostearate). The mono fatty acid derivative of glycerol, and the polyglycerol mono fatty acid derivative, can be used either singly, or in combination, as the antifog agent of the invention.

“Oxygen scavenger”, “oxygen scavenging”, and the like herein means or refers to a composition, compound, film, film layer, coating, plastisol, gasket, or the like which can consume, deplete or react with oxygen from a given environment.

“Internal layer” and the like herein means a layer of a multilayer film that is not an outer layer, i.e. both surfaces of the internal layer are joined to other layers of the film.

“Ethylene/alpha-olefin copolymer” (EAO) herein refers to copolymers of ethylene with one or more comonomers selected from C₃ to C₁₀ alpha-olefins such as propene, butene-1,hexene-1, octene-1, etc. in which the molecules of the copolymers comprise long polymer chains with relatively few side chain branches arising from the alpha-olefin which was reacted with ethylene. This molecular structure is to be contrasted with conventional high pressure low or medium density polyethylenes which are highly branched with respect to EAOs and which high pressure polyethylenes contain both long chain and short chain branches. EAO includes such heterogeneous materials as linear medium density polyethylene (LMDPE), linear low density polyethylene (LLDPE), and very low and ultra low density polyethylene (VLDPE and ULDPE), such as DOWLEX™ or ATTANE™ resins supplied by Dow, and ESCORENE™ or EXCEED™ resins supplied by Exxon; as well as linear homogeneous ethylene/alpha olefin copolymers (HEAO) such as TAFMER™ resins supplied by Mitsui Petrochemical Corporation, EXACT™ resins supplied by Exxon, or long chain branched (HEAO) AFFINITY™ resins supplied by the Dow Chemical Company, or ENGAGE™ resins supplied by DuPont Dow Elastomers.

“Ethylene homopolymer or copolymer” herein refers to ethylene homopolymer such as low density polyethylene; ethylene/alpha olefin copolymer such as those defined herein; ethylene/vinyl acetate copolymer; ethylene/alkyl acrylate copolymer; ethylene/(meth)acrylic acid copolymer; or ionomer resin.

“EVOH” herein refers to the saponified product of ethylene/vinyl ester copolymer, generally of ethylene/vinyl acetate copolymer, wherein the ethylene content is typically between 20 and 60 mole % of the copolymer, and the degree of saponification is generally higher than 85%, preferably higher than 95%.

“Fatty acid” and the like herein means straight chain carboxylic acids ranging from C6 to C22 and may be saturated or unsaturated. Suitable fatty acids include without limitation those derived from edible sources, which occur in nature as mixed fatty acid triglycerides. A mono fatty acid derivative of glycerol or monoglyceride herein shall mean those derivatives that are typically greater than 50% monoesterified. Those skilled in the art will understand that commercial grades of these materials contain diester with a small percentage of the triester and may also contain small amounts of free fatty acids and free glycerol. Polyglycerols are prepared from glycerol and are ethers that contain from 2 to 30 glycerol condensed units. A polyglycerol mono fatty acid derivative is a compound that is typically greater than 50% monoesterified. An example of a fatty acid is stearic acid which typically is greater than 60% C18 with the remainder being primarily palmitic and other fatty acids.

“High density polyethylene” (HDPE) herein refers to a polyethylene having a density of between 0.94 and 0.965 grams per cubic centimeter.

“Ionomer resin” herein refers to a copolymer of ethylene and an ethylenically unsaturated monocarboxylic acid having the carboxylic acid groups partially neutralized by a metal ion, such as sodium or zinc, preferably zinc. Useful ionomers include those:

in which sufficient metal ion is present to neutralize from about 15% to about 60% of the acid groups in the ionomer. The carboxylic acid is preferably “(meth)acrylic acid”—i.e. acrylic acid and/or methacrylic acid;

having at least 50 weight % and preferably at least 80 weight % ethylene units;

having from 1 to 20 weight percent acid units; and

available, for example, from DuPont Corporation (Wilmington, Del.) under the SURLYN trademark.

“Polyamide” herein refers to polymers having amide linkages along the molecular chain, and preferably to synthetic polyamides such as nylons. Furthermore, such term encompasses both polymers comprising repeating units derived from monomers, such as caprolactam, which polymerize to form a polyamide, as well as polymers of diamines and diacids, and copolymers of two or more amide monomers, including nylon terpolymers, sometimes referred to in the art as “copolyamides”. “Polyamide” specifically includes those aliphatic polyamides or copolyamides commonly referred to as e.g. polyamide 6 (homopolymer based on ε-caprolactam), polyamide 6,6 (homopolycondensate based on hexamethylene diamine and adipic acid), polyamide 6,9 (homopolycondensate based on hexamethylene diamine and azelaic acid), polyamide 6,10 (homopolycondensate based on hexamethylene diamine and sebacic acid), polyamide 6,12 (homopolycondensate based on hexamethylene diamine and dodecandioic acid), polyamide 11 (homopolymer based on 11-aminoundecanoic acid), polyamide 12 (homopolymer based on co-aminododecanoic acid or on laurolactam), polyamide 6/12 (polyamide copolymer based on ε-caprolactam and laurolactam), polyamide 6/6,6 (polyamide copolymer based on ε-caprolactam and hexamethylenediamine and adipic acid), polyamide 6,6/6,10 (polyamide copolymers based on hexamethylenediamine, adipic acid and sebacic acid), modifications thereof and blends thereof. Said term also includes crystalline or partially crystalline, or amorphous, aromatic or partially aromatic, polyamides. Examples of partially crystalline aromatic polyamides include meta-xylylene adipamide (MXD6), copolymers such as MXD6/MXDI, and the like. Examples of amorphous, semi-aromatic polyamides nonexclusively include poly(hexamethylene isophthalamide-co-terephthalamide) (PA-6,I/6T), poly(hexamethylene isophthalamide) (PA-6,I), and other polyamides abbreviated as PA-MXDI, PA-6/MXDT/I, PA-6,6/6I and the like.

“Film” herein means a film, laminate, sheet, web, coating, or the like, which can be used to package an oxygen sensitive product. The film can be used as a component in a rigid, semi-rigid, or flexible product, and can be adhered to a non-polymeric or non-thermoplastic substrate such as paper or metal. The film can also be used as a coupon or insert within a package.

“Polymer” and the like herein means a homopolymer, but also copolymers thereof, including bispolymers, terpolymers, etc.

“Trigger” and the like herein means that process defined in U.S. Pat. No. 5,211,875, whereby oxygen scavenging is initiated (i.e. activated) by subjecting an article such as a film to actinic radiation, such as ionizing radiation, such as gamma radiation, having a wavelength of less than about 750 nm at an intensity of at least about 1.6 mW/cm² or an electron beam at a dose of at least 0.2 megarads (MR), wherein after initiation the oxygen scavenging rate of the article is at least about 0.05 cc oxygen per day per gram of oxidizable organic compound for at least two days after oxygen scavenging is initiated. Preferred is a method offering a short “induction period” (the time that elapses, after exposing the oxygen scavenging component to a source of actinic radiation, before initiation of the oxygen scavenging activity begins) so that the oxygen scavenging component can be activated at or immediately prior to use during filling and sealing of a container, made wholly or partly from the article, with an oxygen sensitive material.

Thus, “trigger” refers to subjecting an article to actinic radiation as described above; “triggered” refers to an article that has been subjected to such actinic radiation; “initiation” refers to the point in time at which oxygen scavenging actually begins or is activated; and “induction time” refers to the length of time, if any, between triggering and initiation.

All compositional percentages used herein are presented on a “by weight” basis, unless designated otherwise.

### SUMMARY OF THE INVENTION

In a first aspect of the present invention, a multilayer film comprises a first outer layer comprising a blend of a polymer, and an antifog agent; an internal layer comprising an oxygen scavenger; and a second outer layer comprising a polymer; wherein the antifog agent comprises a material selected from the group consisting of a mono fatty acid derivative of glycerol, and a polyglycerol mono fatty acid derivative; and wherein the first outer layer comprises from 0.1% to 3%, by weight of the first outer layer, of the antifog agent.

In a second aspect of the present invention, a multilayer film comprises a first layer comprising a blend of a polymer and an antifog agent; a second layer comprising an oxygen scavenger; a third layer comprising a polymeric adhesive; a fourth layer comprising a polyamide; a fifth layer comprising an oxygen barrier; a sixth layer comprising a polyamide; a seventh layer comprising a polymeric adhesive; and an eighth layer comprising a polymer; wherein the antifog agent comprises a material selected from the group consisting of a mono fatty acid derivative of glycerol, and a polyglycerol mono fatty acid derivative; and wherein the first layer comprises from 0.1% to 3%, by weight of the first layer, of the antifog agent.

In a third aspect of the present invention, a laminate comprises a multilayer film comprises a first layer comprising a blend of a polymer and an antifog agent; a second layer comprising an oxygen scavenger; a third layer comprising a polymeric adhesive; a fourth layer comprising a polyamide; a fifth layer comprising an oxygen barrier; a sixth layer comprising a polyamide; a seventh layer comprising a polymeric adhesive; and an eighth layer comprising a polymer; and a second film comprising a polyethylene terephthalate, biaxially oriented nylon, biaxially oriented polypropylene, polyvinyl chloride, and polyvinylidene dichloride, the second film bonded to the eighth layer of the multilayer film; wherein the antifog agent comprises a material selected from the group consisting of a mono fatty acid derivative of glycerol, and a polyglycerol mono fatty acid derivative; and wherein the first layer comprises from 0.1% to 3%, by weight of the first layer, of the antifog agent.

In a fourth aspect of the present invention, a laminate comprises a first layer comprising a blend of a polymer, and an antifog agent; a second layer comprising an oxygen scavenger; and a third layer comprising a polymer; and a second film comprising a material selected from the group consisting of polyethylene terephthalate, biaxially oriented nylon, biaxially oriented polypropylene, polyvinyl chloride, and polyvinylidene dichloride, the second film bonded to the third layer of the multilayer film; wherein the antifog agent comprises a material selected from the group consisting of a mono fatty acid derivative of glycerol, and a polyglycerol mono fatty acid derivative; and wherein the first layer comprises from 0.1% to 3%, by weight of the first layer, of the antifog agent.

In a fifth aspect of the present invention, a multilayer film comprises a first layer comprising a blend of a polymer and an antifog agent; a second layer comprising an oxygen scavenger; a third layer comprising a polymeric adhesive; a fourth layer comprising an oxygen barrier; a fifth layer comprising a polymeric adhesive; and an sixth layer comprising a polymer; wherein the antifog agent comprises a material selected from the group consisting of a mono fatty acid derivative of glycerol, and a polyglycerol mono fatty acid derivative; and wherein the first layer comprises from 0.1% to 3%, by weight of the first layer, of the antifog agent.

### DETAILED DESCRIPTION OF THE INVENTION

The oxygen scavenging film may include multiple layers, dependent upon the properties required of the film. For example, layers to achieve appropriate slip, modulus, oxygen or water vapor barrier, oxygen scavenging, meat adhesion, heat seal, or other chemical or physical properties can optionally be included. The film may be manufactured by a variety of processes including, extrusion, coextrusion, lamination, coating, and the like.

An outer layer of the film, preferably a layer that will function as a sealant layer of the film, comprises a blend of one or more polymers with the antifog agent. Polymers that may be used for the surface layer include any resin typically used to formulate packaging films with excellent heat seal properties such as various polyolefin copolymers including ethylene/alpha olefin copolymer, ethylene/vinyl acetate copolymer, ionomer resin, ethylene/acrylic or methacrylic acid copolymer, ethylene/ acrylate or methacrylate copolymer, low density polyethylene, or blends of any of these materials.

The layer or layers comprising the antifog agents may additionally include antiblock agents, slip agents, etc.

Oxygen Barrier Film

High oxygen barrier films can be made from materials having an oxygen permeability, of the barrier material, less than 500 cm³ O₂/m²·day·atmosphere (tested at 1 mil thick and at 25° C. according to ASTM D3985), preferably less than 100, more preferably less than 50 and most preferably less than 25 cm³ O₂/m²·day·atmosphere such as less than 10, less than 5, and less than 1 cm³ O₂/m²·day·atmosphere. Examples of polymeric materials with low oxygen transmission rates are ethylene/vinyl alcohol copolymer (EVOH), polyvinylidene dichloride (PVDC), polyvinyl alcohol, polyacrylonitrile, acrylonitrile copolymer, vinylidene chloride/methyl acrylate copolymer, polyamide, and polyester.

Alternatively, metal foil, liquid crystal polymer, carbon, metal oxide, or SiOx compounds can be used to provide low oxygen transmission to the container. Metallized foils can include a sputter coating or other application of a metal layer to a polymeric substrate such as high density polyethylene (HDPE), ethylene/vinyl alcohol copolymer (EVOH), polypropylene (PP), polyethylene terephthalate (PET), polyethylene naphthalate (PEN), and polyamide (PA).

Alternatively, oxide coated webs (e.g. aluminum oxide or silicon oxide) can be used to provide low oxygen transmission to the container. Oxide coated foils can include a coating or other application of the oxide, such as alumina or silica, to a polymeric substrate such as high density polyethylene (HDPE), ethylene/vinyl alcohol copolymer (EVOH), polypropylene (PP), polyethylene terephthalate (PET),polyethylene naphthalate (PEN), and polyamide (PA).

Even a sufficiently thick layer of a polyolefin such as LLDPE, or PVC (polyvinyl chloride) can in some instances provide a sufficiently low oxygen transmission rate for the overall film for its intended function. The exact oxygen permeability optimally required for a given application can readily be determined through experimentation by one skilled in the art.

Multilayer films of the invention can be made using conventional extrusion, coextrusion, or lamination processes. Likewise, conventional manufacturing processes can be used to make a pouch, a bag, or other container from the film.

Hermetic sealing of a pouch, bag, or other container made from the film of the invention will typically be preferable.

The exact requirements of a container made from the film will depend on a variety of factors, including the chemical nature of the oxygen scavenger, amount of the oxygen scavenger, concentration of the oxygen scavenger in a host material or diluent, physical configuration of the oxygen scavenger, presence of hermetic sealing, vacuumization and/or modified atmosphere inside the container, initial oxygen concentration inside the container, intended end use of the oxygen scavenger, intended storage time of the container before use, level of initial dose of actinic radiation, etc.

The Oxygen Scavenger

Oxygen scavengers suitable for commercial use in articles of the present invention, such as films, are disclosed in U.S. Pat. No. 5,350,622, and a method of initiating oxygen scavenging generally is disclosed in U.S. Pat. No. 5,211,875. Suitable equipment for initiating oxygen scavenging is disclosed in U.S. Pat. No. 6,287,481 (Luthra et al.). These patents are incorporated herein by reference in their entirety. According to U.S. Pat. No. 5,350,622, oxygen scavengers are made of an ethylenically unsaturated hydrocarbon and transition metal catalyst. The preferred ethylenically unsaturated hydrocarbon may be either substituted or unsubstituted. As defined herein, an unsubstituted ethylenically unsaturated hydrocarbon is any compound that possesses at least one aliphatic carbon-carbon double bond and comprises 100% by weight carbon and hydrogen. A substituted ethylenically unsaturated hydrocarbon is defined herein as an ethylenically unsaturated hydrocarbon which possesses at least one aliphatic carbon-carbon double bond and comprises about 50%-99% by weight carbon and hydrogen. Preferable substituted or unsubstituted ethylenically unsaturated hydrocarbons are those having two or more ethylenically unsaturated groups per molecule. More preferably, it is a polymeric compound having three or more ethylenically unsaturated groups and a molecular weight equal to or greater than 1,000 weight average molecular weight.

Examples of unsubstituted ethylenically unsaturated hydrocarbons include, but are not limited to, diene polymers such as polyisoprene, (e.g., trans-polyisoprene) and copolymers thereof, cis and trans 1,4-polybutadiene, 1,2-polybutadienes, (which are defined as those polybutadienes possessing greater than or equal to 50% 1,2 microstructure), and copolymers thereof, such as styrene/butadiene copolymer and styrene/isoprene copolymer. Such hydrocarbons also include polymeric compounds such as polypentenamer, polyoctenamer, and other polymers prepared by cyclic olefin metathesis; diene oligomers such as squalene; and polymers or copolymers with unsaturation derived from dicyclopentadiene, norbornadiene, 5-ethylidene-2-norbornene, 5-vinyl-2-norbornene, 4-vinylcyclohexene, 1,7-octadiene, or other monomers containing more than one carbon-carbon double bond (conjugated or non-conjugated).

Examples of substituted ethylenically unsaturated hydrocarbons include, but are not limited to, those with oxygen-containing moieties, such as esters, carboxylic acids, aldehydes, ethers, ketones, alcohols, peroxides, and/or hydroperoxides. Specific examples of such hydrocarbons include, but are not limited to, condensation polymers such as polyesters derived from monomers containing carbon-carbon double bonds, and unsaturated fatty acids such as oleic, ricinoleic, dehydrated ricinoleic, and linoleic acids and derivatives thereof, e.g. esters. Such hydrocarbons also include polymers or copolymers derived from (meth)allyl (meth)acrylates. Suitable oxygen scavenging polymers can be made by trans-esterification. Such polymers are disclosed in U.S. Pat. No. 5,859,145 (Ching et al.) (Chevron Research and Technology Company), incorporated herein by reference as if set forth in full. The composition used may also comprise a mixture of two or more of the substituted or unsubstituted ethylenically unsaturated hydrocarbons described above. While a weight average molecular weight of 1,000 or more is preferred, an ethylenically unsaturated hydrocarbon having a lower molecular weight is usable, especially if it is blended with a film-forming polymer or blend of polymers.

An additional example of oxygen scavengers which can be used in connection with this invention are disclosed in PCT patent publication WO 99/48963 (Chevron Chemical et al.), incorporated herein by reference in its entirety. These oxygen scavengers include a polymer or oligomer having at least one cyclohexene group or functionality. These oxygen scavengers include a polymer having a polymeric backbone, cyclic olefinic pendent group, and linking group linking the olefinic pendent group to the polymeric backbone.

An oxygen scavenging composition suitable for use with the invention comprises:
(a) a polymer or lower molecular weight material containing substituted cyclohexene functionality according to the following diagram: 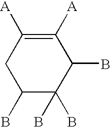
   where A may be hydrogen or methyl and either one or two of the B groups is a heteroatom-containing linkage which attaches the cyclohexene ring to the said material, and wherein the remaining B groups are hydrogen or methyl;
(b) a transition metal catalyst; and optionally
(c) a photoinitiator.

The compositions may be polymeric in nature or they may be lower molecular weight materials. In either case they may be blended with further polymers or other additives. In the case of low molecular weight materials they will most likely be compounded with a carrier resin before use.

When used in forming a packaging article, the oxygen scavenging composition of the present invention can include only the above-described polymers and a transition metal catalyst. However, photoinitiators can be added to further facilitate and control the initiation of oxygen scavenging properties. Suitable photoinitiators are known to those skilled in the art. Specific examples include, but are not limited to, benzophenone, and its derivatives, such as methoxybenzophenone, dimethoxybenzophenone, dimethylbenzophenone, diphenoxybenzophenone, allyloxybenzophenone, diallyloxybenzophenone, dodecyloxybenzophenone, dibenzosuberone, 4,4′-bis(4-isopropylphenoxy)benzophenone, 4-morpholinobenzophenone, 4-aminobenzophenone, tribenzoyl triphenylbenzene, tritoluoyl triphenylbenzene, 4,4′-bis(dimethylamino)benzophenone, acetophenone and its derivatives, such as, o-methoxy-acetophenone, 4′-methoxyacetophenone, valerophenone, hexanophenone, α-phenylbutyrophenone, p-morpholinopropiophenone, benzoin and its derivatives, such as, benzoin methyl ether, benzoin butyl ether, benzoin tetrahydropyranyl ether, 4-o-morpholinodeoxybenzoin, substituted and unsubstituted anthraquinones, α-tetralone, acenaphthenequinone, 9-acetylphenanthrene, 2-acetyl-phenanthrene, 10-thioxanthenone, 3-acetyl-phenanthrene, 3-acetylindole, 9-fluorenone, 1-indanone, 1,3,5-triacetylbenzene, thioxanthen-9-one, isopropylthioxanthen-9-one, xanthene-9-one, 7-H-benz[de]anthracen-7-one, 1′-acetonaphthone, 2′-acetonaphthone, acetonaphthone, 2,4,6-trimethylbenzoyldiphenylphosphine oxide, bis(2,4,6-trimethylbenzoyl)phenylphosphine oxide, ethyl-2,4,6-trimethylbenzoylphenyl phosphinate, bis(2,6-dimethoxybenzoyl)-2,4,4-trimethylpentyl phosphine oxide, benz[a]anthracene-7,12-dione, 2,2-dimethoxy-2-phenylacetophenone, α,α-diethoxyacetophenone, α,α-dibutoxyacetophenone, 4-benzoyl-4′-methyl(diphenyl sulfide) and the like. Single oxygen-generating photosensitizers such as Rose Bengal, methylene blue, and tetraphenylporphine as well as polymeric initiators such as poly(ethylene carbon monoxide) and oligo[2-hydroxy-2-methyl-1-[4-(1-methylvinyl)phenyl]propanone] also can be used. The amount of photoinitiator can depend on the amount and type of cyclic unsaturation present in the polymer, the wavelength and intensity of radiation used, the nature and amount of antioxidants used, and the type of photoinitiator used.

Also suitable for use in the present invention is the oxygen scavenger of U.S. Pat. No. 6,255,248 (Bansleben et al.), incorporated herein by reference in its entirety, which discloses a copolymer of ethylene and a strained, cyclic alkylene, preferably cyclopentene; and a transition metal catalyst.

Another oxygen scavenger which can be used in connection with this invention is the oxygen scavenger of U.S. Pat. No. 6,214,254 (Gauthier et al.), incorporated herein by reference in its entirety, which discloses ethylene/vinyl aralkyl copolymer and a transition metal catalyst.

As indicated above, the ethylenically unsaturated hydrocarbon is combined with a transition metal catalyst. Suitable metal catalysts are those which can readily interconvert between at least two oxidation states.

The catalyst can be in the form of a transition metal salt, with the metal selected from the first, second or third transition series of the Periodic Table. Suitable metals include, but are not limited to, manganese II or II, iron II or II, cobalt II or II, nickel II or III, copper I or II, rhodium II, III or IV, and ruthenium II or III. The oxidation state of the metal when introduced is not necessarily that of the active form. The metal can be e.g. iron, nickel, copper, manganese, or cobalt. Suitable counterions for the metal include, but are not limited to, chloride, acetate, stearate, palmitate, caprylate, linoleate, tallate, 2-ethylhexanoate, neodecanoate, oleate or naphthenate. Useful salts include cobalt (II) 2-ethylhexanoate, cobalt stearate, and cobalt (II) neodecanoate. The metal salt may also be an ionomer, in which case a polymeric counterion is employed. Such ionomers are well known in the art.

Any of the above-mentioned oxygen scavengers and transition metal catalyst can be further combined with one or more polymeric diluents, such as thermoplastic polymers which are typically used to form film layers in plastic packaging articles. In the manufacture of certain packaging articles well known thermosets can also be used as the polymeric diluent.

Further additives can also be included in the composition to impart properties desired for the particular article being manufactured. Such additives include, but are not necessarily limited to, fillers, pigments, dyestuffs, antioxidants, stabilizers, processing aids, plasticizers, fire retardants, etc.

The mixing of the components listed above is preferably accomplished by melt blending at a temperature in the range of 50° C. to 300° C. However, alternatives such as the use of a solvent followed by evaporation may also be employed.

Oxygen scavenging structures can sometimes generate reaction byproducts, which can affect the taste and smell of the packaged material (i.e. organoleptic properties), or raise food regulatory issues. This problem can be minimized by the use of polymeric functional barriers. Polymeric functional barriers for oxygen scavenging applications are disclosed in WO 96/08371 to Ching et al. (Chevron Chemical Company), WO 94/06626 to Balloni et al., and copending U.S. patent application Ser. No. 08/813752 (Blinka et al.) and Ser. No. 09/445645 (Miranda), all of which are incorporated herein by reference as if set forth in full, and include high glass transition temperature (T_{g}) glassy polymers such as polyethylene terephthalate (PET) and nylon 6 that can be further oriented; low T_{g} polymers and their blends; a polymer derived from a propylene monomer; a polymer derived from a methyl acrylate monomer; a polymer derived from a butyl acrylate monomer; a polymer derived from a methacrylic acid monomer; polyethylene terephthalate glycol (PETG); amorphous nylon; ionomer; a polymeric blend including a polyterpene; and poly (lactic acid). The functional barriers can be incorporated into one or more layers of a multilayer film or other article that includes an oxygen scavenging layer.

### Resin Identification

| Material | Tradename Or | |
|---|---|---|
| Code | Designation | Source(s) |
| AB1 | 10853 ™ | Ampacet |
| AB2 | KAOPOLITE SF | Kaopolite |
| AD1 | Polyurethane adhesive | — |
| AD2 | PLEXAR ™ PX 1007 ™ | Equistar |
| AD3 | BYNEL ™ CXA 4104 | DuPont |
| AD4 | BYNEL ™ CXA 39E660 | DuPont |
| AF1 | ELECUTMASTER ™ E-1000 | Goulston |
| AF2 | ATMOS ™ 300K SPECIAL ™ | Crompton |
| AF3 | ELECUT ™ E-128 | Goulston |
| EV1 | PE 1335 ™ | Huntsman |
| NY1 | ULTRAMID ™ B 35 NATURAL | BASF |
| NY2 | GRIVORY ™ G21 | EMS |
| NY3 | GRILON ™ CF6S | EMS |
| NY4 | ULTRAMID ™ B 35 FN | BASF |
| NY5 | CAPRON ™ B100WP | BASF |
| OB1 | SOARNOL ™ ET 3803 | Nippon Gohsei |
| OB2 | EVAL ™ E151A | EVALCA/Kuraray |
| OS1 | OSP500R ™ | Chevron Phillips |
| OSM | OSP100M ™ | Chevron Phillips |
| PE1 | DOWLEX ™ 2045.04 | Dow |
| PE2 | DOWLEX ™ 2037 | Dow |
| PE3 | PE1042CS15 ™ | Huntsman |
| PE4 | AFFINITY PL 1850G ™ | Dow |
| PE5 | SLP-9072 ™ | ExxonMobil |
| PET1 | HOSTAPHAN 2DEF/2DEFN ™ | Mitsubishi |
| SB1 | STYROLUX ™ 684D | BASF |
| SL1 | FSU ™ 93E ™ | A. Schulman |
| SL2 | 1080864S ™ | Clariant |
| SL3 | GRILON ™ MB 3361FS NATURAL | EMS |
| SX1 | MB50-313 ™ | Dow Corning |

AB1 is a masterbatch having about 80% linear low density polyethylene, and about 20% of an antiblocking agent (diatomaceous earth).

AB2 is an anhydrous aluminum silicate that acts as an antiblocking agent.

AD1 is a polyurethane adhesive.

AD2 is a maleic anhydride grafted polyolefin in ethylene/vinyl acetate copolymer (EVA), with between 9% and 11% vinyl acetate monomer, and a melt index of 3.2, used as an adhesive or tie layer.

AD3 is an anhydride grafted polyolefin in ethylene/butene copolymer, used as an adhesive or tie layer.

AD4 is a maleic anhydride grafted ethylene copolymer in ethylene/vinyl acetate copolymer (EVA) with 12% vinyl acetate monomer, and a melt index of 2.5, used as an adhesive or tie layer.

AF1 is a masterbatch having 85% linear low density polyethylene (acting as a carrier resin), 12% of a blend of 50% glycerol monostearate and 50% polyglycerol monostearate (these two materials acting as antifog agents), and 3% silicon dioxide (acting as an antiblock agent).

AF2 is a glycerol fatty acid ester antifog agent having a blend of about 88% mono- and diglycerides, and about 12% propylene glycol.

AF3 is a masterbatch having 85% low density polyethylene (acting as a carrier resin), 12% of a blend of 50% glycerol monostearate and 50% polyglycerol monostearate (these two materials acting as antifog agents), and 3% silicon dioxide (acting as an antiblock agent).

EV1 is ethylene/vinyl acetate copolymer with 3.3% vinyl acetate monomer, and a melt index of 2.0.

NY1 is nylon 6 (polycaprolactam).

NY2 is an amorphous copolyamide (6I/6T) derived from hexamethylene diamine, isophthalic acid, and terephthalic acid.

NY3 is nylon 6/12 (caprolactam/laurolactam copolyamide).

NY4 is nylon 6 (polycaprolactam).

NY5 is nylon 6 (polycaprolactam).

OB1 is an ethylene/vinyl alcohol copolymer with 38 mole percent ethylene.

OB2 is an ethylene/vinyl alcohol copolymer with 44 mole percent ethylene.

OS1 is an oxygen scavenger resin, poly(ethylene/methyl acrylate/cyclohexene methyl acrylate).

OSM is a masterbatch produced from a carrier resin (ethylene/methyl acrylate) designated SP2260 from Voridian, with 1%, by weight of the masterbatch, of cobalt present in a prill (solid) cobalt oleate from Shepherd Chemical, and 1%, by weight of the masterbatch, of tribenzoyl triphenyl benzene from Chemfirst Fine Chemicals, Inc.

PE1 is a linear ethylene/1-octene copolymer with a density of 0.920 gm/cc and an octene-1 comonomer content of 6.5%, and a melt flow index of 1.0.

PE2 is a linear ethylene/1-octene copolymer with a density of 0.935 gm/cc and an octene-1 comonomer content of 2.5%, and a melt flow index of 2.5

PE3 is a low density polyethylene resin with a density of 0.922 grams/cc.

PE4 is a single site catalyzed ethylene/1-octene copolymer with a density of 0.902 grams/cc, a melt index of 3.0, and an octene-1 comonomer content of 12%.

PE5 is a single site catalyzed ethylene/hexene copolymer with a density of 0.901 grams/cc, and a melt index of 2.0.

PET1 is a chemically primed polyethylene terephthalate film.

SB1 is a styrene/butadiene/styrene block copolymer with 76% styrene by weight of the copolymer.

SL1 is a masterbatch having about 88% low density polyethylene with 9% silica (an antiblock agent) and 3% erucamide (a slip agent).

SL2 is a masterbatch having about 70% nylon 6, 20% diatomaceous earth (an antiblock agent), and 10% erucamide (a slip agent).

SL3 is a masterbatch having nylon 6 with an antiblock agent and a slip agent).

SX1 is a polysiloxane masterbatch in an LLDPE carrier resin with a density of 0.94 grams/cc.

All compositional percentages given herein are by weight, unless indicated otherwise.

### EXAMPLES

Experiments utilizing sealant layers comprising antifog agents were performed to evaluate the antifog properties of the sealant layer of oxygen scavenging films. Antifog performance of each of the films was determined according to the following method. Each film sample was irradiated with either a Cryovac model 4104V SIS unit or an Anderson/Vreeland unit to give a dose of 700-800 mJ/cm² of UV C radiation. Tap water (300 mL) was placed in a 600 mL beaker and allowed to equilibrate at room temperature, 75° F. (24° C.). A piece of the film, with the sealant side facing the water, was formed tightly over the beaker and secured with a rubber band. The beaker was then placed in a refrigerated cooler at 3540° F. (2-5° C.). Triplicate film specimens on beakers were prepared for each film sample. The specimens were then observed after 48 hours and antifog performance was rated. In rating antifog performance, a 1 to 5 scale was used. A rating of 1 is the worst and an opaque layer of small fog droplets less than ⅛″ (3 mm), with minimum light visibility and poor light transmission, is observed. A rating of 2 has opaque to semi-transparent fog droplets greater than 1/8″ (3 mm), with poor visibility and light transmission, noted. Large semi-transparent to transparent drops greater than ¼″ (6 mm), with better visibility and a lens effect due to the droplets is observed for a rating of 3. A rating of 4 has randomly scattered large transparent drops and thus a discontinuous film of water. A rating of 5 is the best and a transparent film with no visible water is noted.

To determine the oxygen scavenging rate of the films, two methods were used to prepare and evaluate the films. In both cases, film samples were UV irradiated with either a Cryovac Model 4104V Scavenging Initiation System (SIS) unit or an Anderson/Vreeland unit to give a dose of 700-800 mJ/cm² of UV C. In one method, irradiated films of well-defined area (usually 200 cm²) were then vacuum packaged in barrier pouches (P 640B, Cryovac® division of Sealed Air Corp., OTR=5 cc/m²/day). The pouches were inflated with 300 cc of nitrogen atmosphere at about 1% residual oxygen. In the second method, irradiated film samples were used as lidstock on a Multivac R230 packaging machine, along with bottom web (T6070B, Cryovac® division of Sealed Air Corp.). Gas flushing with the same 1% residual oxygen was also utilized. Samples were then stored at 4-5° C. (refrigerated) for the duration of the test. Portions of the headspace were periodically withdrawn and analyzed for oxygen with a Mocon PAC-CHECK™ model 400 or 450 oxygen analyzer. The average oxygen scavenging rate is calculated by considering only the end points, with the following formula: Average Rate=cc O₂ scavenged/(m²·day), and in these examples was calculated 4 days after UV triggering. The peak (instantaneous) rate is the highest scavenging rate observed during any sampling period, and is given by: Δcc O₂ scavenged/(m²·Δday), where Δ is the incremental change between two consecutive measurements. Measurements are typically taken on the day of triggering and after 1, 4, 7, 14, and 21 days after triggering. Rates are further reported as the mean of at least three replicates.

Eight layer oxygen scavenging films with an antifog agent (AF1) containing sealant layer and having oxygen barrier properties were prepared and then laminated with solvent-based adhesive (AD1) to chemically primed PET (PET1). The film structure, as well as the 48 hour antifog performance and refrigerated oxygen scavenging performance after UV triggering, are seen below. For comparison, several multilayer film structures of non-oxygen scavenging, antifog film containing an antifog agent, and their 48 hour antifog performance, are shown.

The percentages shown in the examples reflect the commercial resins used. The additives shown in the sealant layer of Example 1 include an active component in a masterbatch. The antiblock agent AB1 is 10853 from Ampacet. This composition contains about 20%, by weight of the commercial material, of silica in the form of a diatomaceous earth, blended in a host polymer, linear low density polyethylene. Therefore, although the AB1 forms about 8% of the sealant layer, the active antiblock material (silica) within AB1 forms about 1.6% of the composition of the sealant layer. Likewise, the slip agent SX1 is MB50-313 from Dow Corning. This composition contains approximately 50%, by weight of the commercial material, of siloxane. Thus, although the SX1 forms about 3% of the sealant layer, the active slip material (siloxane) within SX1 forms about 1.5% of the composition of the sealant layer. The same holds true for AB1 and SX1 appearing elsewhere in the examples.

### Example 1

| Sealant | OS | Tie | Nylon | EVOH | Nylon | Tie | Bulk | Adhesive | PET |
|---|---|---|---|---|---|---|---|---|---|
| 87% PE4 + 8% | 90% OS1 + 10% | AD2 | 80% NY1 + 20% | OB1 | 80% NY1 + 20% | AD2 | PE3 | AD1 | PET1 |
| AB1 + 3% | OSM | | NY2 | | NY2 | | | | |
| SX1 + 2% | | | | | | | | | |
| AF1¹ | | | | | | | | | |
| 0.25 mil | 0.75 mil | 0.18 mil | 0.18 mil | 0.25 mil | 0.19 mil | 0.2 mil | 0.5 mil | 0.05 mil | 0.5 mil |

¹The percentages of AF1 shown in the examples include the amount of active antifog component in masterbatch form.
The antifog agent AF1 contains about 12% of a blend of glycerol and polyglycerol fatty acid ester antifog agents containing
about 50% glycerol stearate and about 50% polyglycerol stearate. Therefore in Example 1, although AF1 forms
about 2% of the sealant layer and about 0.2% of the coextruded eight-layer film structure before lamination with AD1 to PET1,
the active antifog agent forms about 0.25% of the sealant layer and about 0.25% of the coextruded eight-layer film structure
before lamination with AD1 to PET1.

| 48 Hour UV Triggered | Refrigerated OS Rate (cc/m²/day) |
|---|---|
| Antifog | Average and Peak Values |
| 5.0 | 35.8 and 53.4 |

### Example 2

| Sealant | OS | Tie | Nylon | EVOH | Nylon | Tie | Bulk | Adhesive | PET |
|---|---|---|---|---|---|---|---|---|---|
| 85% PE4 + 8% | 90% OS1 + 10% | AD2 | 80% NY1 + 20% | OB1 | 80% NY1 + 20% | AD2 | PE3 | AD1 | PET1 |
| AB1 + 3% | OSM | | NY2 | | NY2 | | | | |
| SX1 + 4% | | | | | | | | | |
| AF1² | | | | | | | | | |
| 0.25 mil | 0.75 mil | 0.18 mil | 0.18 mil | 0.25 mil | 0.19 mil | 0.2 mil | 0.5 mil | 0.05 mil | 0.5 mil |

²The active antifog agent forms about 0.5% of the sealant layer and about 0.05% of the coextruded eight-layer film
structure before lamination with AD1 to PET1.

| | Refrigerated OS Rate |
|---|---|
| 48 Hour UV Triggered | (cc/m²/day) |
| Antifog | Average and Peak Values |
| 5.0 | 28.5 and 33.7 |

### Example 3

| Sealant | OS | Tie | Nylon | EVOH | Nylon | Tie | Bulk | Adhesive | PET |
|---|---|---|---|---|---|---|---|---|---|
| 82% PE4 + 7% | 90% OS1 + 10% | AD2 | 80% NY1 + 20% | OB1 | 80% NY1 + 20% | AD2 | PE3 | AD1 | PET1 |
| AB1 + 3% | OSM | | NY2 | | NY2 | | | | |
| SX1 + 8% | | | | | | | | | |
| AF1³ | | | | | | | | | |
| 0.25 mil | 0.75 mil | 0.18 mil | 0.18 mil | 0.25 mil | 0.19 mil | 0.2 mil | 0.5 mil | 0.05 mil | 0.5 mil |

³The active antifog agent forms about 1.0% of the sealant layer and about 0.1% of the coextruded eight-layer
film structure before lamination with AD1 to PET1.

| 48 Hour UV Triggered | Refrigerated OS Rate (cc/m²/day) |
|---|---|
| Antifog | Average and Peak Values |
| 5.0 | 34.1 and 39.2 |

### Example 4

| Sealant | OS | Tie | Nylon | EVOH | Nylon | Tie | Bulk | Adhesive | PET |
|---|---|---|---|---|---|---|---|---|---|
| 74% PE4 + 6% | 90% OS1 + 10% | AD2 | 80% NY1 + 20% | OB1 | 80% NY1 + 20% | AD2 | PE3 | AD1 | PET1 |
| AB1 + 3% | OSM | | NY2 | | NY2 | | | | |
| SX1 + 17% | | | | | | | | | |
| AF1⁴ | | | | | | | | | |
| 0.25 mil | 0.75 mil | 0.18 mil | 0.18 mil | 0.25 mil | 0.19 mil | 0.2 mil | 0.5 mil | 0.05 mil | 0.05 mil |

⁴The active antifog agent forms about 2.0% of the sealant layer and about 0.2% of the coextruded eight-layer
film structure before lamination with AD1 to PET1.

| 48 Hour UV Triggered | Refrigerated OS Rate (cc/m²/day) |
|---|---|
| Antifog | Average and Peak Values |
| 5.0 | 33.5 and 53.7 |

### Comparative Example 5

| Sealant | Substrate | Core | Substrate | Sealant |
|---|---|---|---|---|
| 48% PE1 + | AD3 | 90% OB2 + | AD3 | 48% PE1 + 24% |
| 24% EV1 + | | 10% NY3 | | EV1 + 24% |
| 24% PE2 + | | | | PE2 + 2% |
| 2% AB2 + | | | | AB2 + 2% |
| 2% AF3⁸ | | | | AF3⁸ |
| 0.22 mil | 0.22 mil | 0.12 mil | 0.22 mil | 0.22 mil |

⁸The percentages of AF3 shown in the examples include the amount of
active antifog component in masterbatch form.
The antifog agent AF3 contains about 12% of a blend of
glycerol and polyglycerol fatty acid ester antifog agents containing about
50% glycerol stearate and about 50% polyglycerol stearate. Therefore in
Comparative Example 5, although AF3 forms about 2% of
each of the two sealant layers and about 0.88% of the coextruded
five-layer film structure, the active antifog agent forms about
0.25% of each of the two sealant layers and about 0.11% of the
coextruded five-layer film structure.
48 Hour
Antifog
3.0

### Comparative Example 6

| Sealant | Substrate | Core | Substrate | Sealant |
|---|---|---|---|---|
| 47% PE1 + | AD3 | 90% OB2 + | AD3 | 47% PE1 + |
| 23.5% EV1 + | | 10% NY3 | | 23.5% EV1 + |
| 23.5% PE2 + | | | | 23.5% PE2 + |
| 2% AB2 + | | | | 2% AB2 + |
| 4% AF3⁹ | | | | 4% AF3⁹ |
| 0.22 mil | 0.22 mil | 0.12 mil | 0.22 mil | 0.22 mil |

⁹The active antifog agent forms about 0.5% of each of the two
sealant layers and about 0.21% of the coextruded five-layer film
structure.
48 Hour
Antifog
3.0

### Comparative Example 7

| Sealant | Core | Sealant |
|---|---|---|
| 92% PE5 + 4% | SB1 | 96% PE5 + 4% |
| SL1 + 4% | | SL1 + |
| AF3¹⁰ | | |
| 0.5 mil | 0.5 mil | 0.5 mil |

¹⁰The active antifog agent forms about 0.5% of the sealant layer
and about 0.16% of the coextruded three-layer film structure.
48 Hour
Antifog
3.5

### Example 8

### Proposed Structure

| Nylon | Tie | Nylon | Nylon | EVOH | Nylon | Tie | OSL | Sealant |
|---|---|---|---|---|---|---|---|---|
| 74% NY4 | AD4 | NY2 | 80% NY5 | OB1 | 80% | AD4 | 90% OS1 | Sealant |
| 20% NY2 | | | 20% NY2 | | NY5 | | 10% OSM1 | Antiblock |
| 3% SL2 | | | | | 20% | | | Slip |
| 3% SL3 | | | | | NY2 | | | |
| 0.35 mil | 0.70 mil | 0.42 mil | 0.28 mil | 0.21 mil | 0.28 mil | 0.28 mil | 0.74 mil | 0.25 mil |
| | or | | | | | or | | |
| | 0.63 mil | | | | | 0.35 mil | | |

The structure of Example 8 would be totally coextruded by conventional coextrusion technology. The sealant layer would include from 0.1% to 3%, by weight of the sealant layer, of a mono fatty acid derivative of glycerol, and/or a polyglycerol mono fatty acid derivative.

### Example 9

### Proposed Structure

A structure is made like that of the eight layer film of Example 1 (disregarding the PET layer, and the adhesive that binds the PET layer to the antifog film), but in which the two internal nylon layers are absent from the structure. The structure is thus a six layer, totally coextruded film, having a structure as follows:

| Sealant | OS | Tie | EVOH | Tie | Bulk |
|---|---|---|---|---|---|
| 87% PE4 + 8% | 90% OS1 + 10% | AD2 | OB1 | AD2 | PE3 |
| AB1 + 3% | OSM | | | | |
| SX1 + 2% | | | | | |
| AF1¹ | | | | | |
| 0.25 mil | 0.75 mil | 0.18 mil | 0.25 mil | 0.2 mil | 0.5 mil |

### Example 10

### Proposed Structure

A structure is made like that of the eight layer film of Example 2 (disregarding the PET layer, and the adhesive that binds the PET layer to the antifog film), but in which the two internal nylon layers are absent from the structure. The structure is thus a six layer, totally coextruded film, having a structure as follows:

| Sealant | OS | Tie | EVOH | Tie | Bulk |
|---|---|---|---|---|---|
| 85% PE4 + 8% | 90% OS1 + 10% | AD2 | OB1 | AD2 | PE3 |
| AB1 + 3% | OSM | | | | |
| SX1 + 4% | | | | | |
| AF1² | | | | | |
| 0.25 mil | 0.75 mil | 0.18 mil | 0.25 mil | 0.2 mil | 0.5 mil |

### Example 11

### Proposed Structure

A structure is made like that of the eight layer film of Example 3 (disregarding the PET layer, and the adhesive that binds the PET layer to the antifog film), but in which the two internal nylon layers are absent from the structure. The structure is thus a six layer, totally coextruded film, having a structure as follows:

| Sealant | OS | Tie | EVOH | Tie | Bulk |
|---|---|---|---|---|---|
| 82% PE4 + 7% | 90% OS1 + 10% | AD2 | OB1 | AD2 | PE3 |
| AB1 + 3% | OSM | | | | |
| SX1 + 8% | | | | | |
| AF1³ | | | | | |
| 0.25 mil | 0.75 mil | 0.18 mil | 0.25 mil | 0.2 mil | 0.5 mil |

### Example 12

### Proposed Structure

A structure is made like that of the eight layer film of Example 4 (disregarding the PET layer, and the adhesive that binds the PET layer to the antifog film), but in which the two internal nylon layers are absent from the structure. The structure is thus a six layer, totally coextruded film, having a structure as follows:

| Sealant | OS | Tie | EVOH | Tie | Bulk |
|---|---|---|---|---|---|
| 74% PE4 + 6% | 90% OS1 + 10% | AD2 | OB1 | AD2 | PE3 |
| AB1 + 3% | OSM | | | | |
| SX1 + 17% | | | | | |
| AF1⁴ | | | | | |
| 0.25 mil | 0.75 mil | 0.18 mil | 0.25 mil | 0.2 mil | 0.5 mil |

### Examples 13

### Proposed

A totally coextruded nine layer film has the following structure:

| | | | | | | | | |
|---|---|---|---|---|---|---|---|---|
| PP* | PP* | Adhesive | polyamide | Oxygen | polyamide | adhesive | Oxygen | Sealant |
| | | | | barrier | | | scavenger | Antiblock |
| | | | | | | | | Slip |

*PP = polypropylene or ethylene/propylene copolymer

The sealant layer would include from 0.1% to 3%, by weight of the sealant layer, of a mono fatty acid derivative of glycerol, and/or a polyglycerol mono fatty acid derivative.

### Examples 14 to 17

### Proposed

A structure is made like that of each of the six layer films of Examples 9 through 12 respectively, but in which a second film comprising a polyethylene terephthalate (PET), biaxially oriented nylon, biaxially oriented polypropylene, or polyvinylidene dichloride, is adhered to each respective film by an adhesive that binds the PET, etc. layer to the antifog film.

In comparing Examples 1 and 2 with Comparative Examples 5, 6, and 7, one can see how having the antifog agent in an outer layer adjacent to an OS layer, enhances antifog performance with the same antifog agent (glycerol monostearate and polyglycerol monostearate) at much lower overall film loadings (0.025% versus >0.21%) to achieve similar antifog performance.

The first outer layer of a film of the invention comprises from 0.1% to 3% antifog agent, by weight of the first outer layer, such as from 0.25% to 2.5% antifog agent, or from 0.5% to 2% antifog agent, such as 1% to 1.5%, by weight of the first outer layer. The second outer layer comprises less than 3% antifog agent, by weight of the second outer layer; such as less than 2%, less than 1%, and less than 0.5% antifog agent by weight of the second outer layer, and in one embodiment the second outer layer does not have any extruded antifog agent.

Polymeric adhesives that can be used in embodiments of the present invention include e.g. ethylene/vinyl acetate copolymer; anhydride grafted ethylene/vinyl acetate copolymer; anhydride grafted ethylene/alpha olefin copolymer; and anhydride grafted low density polyethylene.

Second Film

Although the second film is shown herein as a PET film, other materials can be used, e.g. biaxially oriented nylon, biaxially oriented polypropylene, polyvinyl chloride, and polyvinylidene dichloride. The second film can be optionally coated with an oxygen barrier layer. This option can be beneficial where the antifog containing film does not itself include an oxygen barrier.

### Printed Embodiments

Films of the invention, including any of the examples disclosed herein, can optionally be printed by any suitable printing technology. The printing can be in the form of a logo, written indicia, graphics, or any combination thereof.

Films not laminated to a second film can be surface printed. These films can optionally include an overprint varnish. Although either outer surface of the film can be printed, the film is beneficially printed on the surface not containing antifog material, or containing less antifog material than the opposite surface of the film.

For films that are laminated to a second film, e.g. to a PET film, the PET or other second film can be reverse or trap printed before laminating the second film to the antifog containing film. Alternatively, the second film can be laminated to the antifog containing film, and then the second film can be printed on the surface thereof opposite the side adhered to the antifog containing film.

The invention is not limited to the illustrations described herein, which are deemed to be merely illustrative, and susceptible of modification of form, size, arrangement of parts and details of operation.

What is claimed is:

1. A multilayer film comprising:
a) a first outer layer comprising a blend of
i) a polymer, and
ii) an antifog agent;
b) an internal layer comprising an oxygen scavenger; and
c) a second outer layer comprising a polymer;
wherein the antifog agent comprises a material selected from the group consisting of:
i) a mono fatty acid derivative of glycerol, and
ii) a polyglycerol mono fatty acid derivative; and
wherein the first outer layer comprises from 0.1% to 3%, by weight of the first outer layer, of the antifog agent.

2. The multilayer film of claim 1 wherein the polymer of the first and second outer layers comprises a material selected from the group consisting of:
a) ethylene/alpha olefin copolymer;
b) ethylene/vinyl acetate copolymer;
c) ionomer resin;
d) ethylene/acrylic or methacrylic acid copolymer;
e) ethylene/acrylate or methacrylate copolymer; and
f) low density polyethylene.

3. The multilayer film of claim 1 wherein the oxygen scavenger comprises a material selected from the group consisting of:
i) oxidizable organic compound and a transition metal catalyst,
ii) ethylenically unsaturated hydrocarbon and a transition metal catalyst,
iii) a polymer having a polymeric backbone, cyclic olefinic pendent group, and linking group linking the olefinic pendent group to the polymeric backbone,
iv) a copolymer of ethylene and a strained, cyclic alkylene,
v) ethylene/vinyl aralkyl copolymer,
vi) ascorbate,
vii) isoascorbate,
viii) sulfite,
ix) ascorbate and a transition metal catalyst, the catalyst comprising a simple metal or salt, or a compound, complex or chelate of the transition metal,
x) a transition metal complex or chelate of a polycarboxylic acid, salicylic acid, or polyamine,
xi) a tannin, and
xii) reduced metal.

4. The film of claim 1 comprising an oxygen barrier layer, disposed between the internal layer comprising the oxygen scavenger, and one of the first and second outer layers, the oxygen barrier layer having an oxygen transmission rate of no more than 100 cc/m²/24 hr at 25° C., 0% RH, 1 atm (ASTM D 3985).

5. The film of claim 1 wherein the average oxygen scavenging rate of the film is at least 25 cc/m²/day for at least two days after the oxygen scavenging property of the film is activated.

6. The film of claim 1 wherein the film is cross-linked.

7. The film of claim 1 wherein the film is biaxially oriented and heat shrinkable.

8. A multilayer film comprising:
a) a first layer comprising a blend of:
i) a polymer, and
ii) an antifog agent;
b) a second layer comprising an oxygen scavenger;
c) a third layer comprising a polymeric adhesive;
d) a fourth layer comprising a polyamide;
e) a fifth layer comprising an oxygen barrier;
f) a sixth layer comprising a polyamide;
g) a seventh layer comprising a polymeric adhesive; and
h) an eighth layer comprising a polymer;
wherein the antifog agent comprises a material selected from the group consisting of:
i) a mono fatty acid derivative of glycerol, and
ii) a polyglycerol mono fatty acid derivative; and
wherein the first outer layer comprises from 0.1% to 3%, by weight of the first outer layer, of the antifog agent.

9. The multilayer film of claim 8 wherein the polymer of the first and eighth layers comprises a material selected from the group consisting of:
a) ethylene/alpha olefin copolymer;
b) ethylene/vinyl acetate copolymer;
c) ionomer resin;
d) ethylene/acrylic or methacrylic acid copolymer;
e) ethylene/acrylate or methacrylate copolymer; and
f) low density polyethylene.

10. The multilayer film of claim 8 wherein the oxygen scavenger of the second layer comprises a material selected from the group consisting of:
i) oxidizable organic compound and a transition metal catalyst,
ii) ethylenically unsaturated hydrocarbon and a transition metal catalyst,
iii) a polymer having a polymeric backbone, cyclic olefinic pendent group, and linking group linking the olefinic pendent group to the polymeric backbone,
iv) a copolymer of ethylene and a strained, cyclic alkylene,
v) ethylene/vinyl aralkyl copolymer,
vi) ascorbate,
vii) isoascorbate,
viii) sulfite,
ix) ascorbate and a transition metal catalyst, the catalyst comprising a simple metal or salt, or a compound, complex or chelate of the transition metal,
x) a transition metal complex or chelate of a polycarboxylic acid, salicylic acid, or polyamine,
xi) a tannin, and
xii) reduced metal.

11. The multilayer film of claim 8 wherein the polymeric adhesive of the third and seventh layers comprises a material selected from the group consisting of:
i) ethylene/vinyl acetate copolymer;
ii) anhydride grafted ethylene/vinyl acetate copolymer;
iii) anhydride grafted ethylene/alpha olefin copolymer; and
iv) anhydride grafted low density polyethylene.

12. A laminate comprising:
a) a multilayer film comprising:
i) a first layer comprising a blend of:
(a) a polymer, and
(b) an antifog agent;
ii) a second layer comprising an oxygen scavenger;
iii) a third layer comprising a polymeric adhesive;
iv) a fourth layer comprising a polyamide;
v) a fifth layer comprising an oxygen barrier;
vi) a sixth layer comprising a polyamide;
vii) a seventh layer comprising a polymeric adhesive; and
viii) an eighth layer comprising a polymer, and
b) a second film comprising a material selected from the group consisting of:
i) polyethylene terephthalate,
ii) biaxially oriented nylon,
iii) biaxially oriented polypropylene,
iv) polyvinyl chloride, and
v) polyvinylidene dichloride,
the second film bonded to the eighth layer of the multilayer film;
wherein the antifog agent comprises a material selected from the group consisting of:
i) a mono fatty acid derivative of glycerol, and
ii) a polyglycerol mono fatty acid derivative; and
wherein the first outer layer comprises from 0.1% to 3%, by weight of the first outer layer, of the antifog agent.

13. The multilayer film of claim 12 wherein the polymer of the first and eighth layers comprises a material selected from the group consisting of:
a) ethylene/alpha olefin copolymer;
b) ethylene/vinyl acetate copolymer;
c) ionomer resin;
d) ethylene/acrylic or methacrylic acid copolymer;
e) ethylene/acrylate or methacrylate copolymer; and
f) low density polyethylene.

14. The multilayer film of claim 12 wherein the oxygen scavenger of the second layer comprises a material selected from the group consisting of:
i) oxidizable organic compound and a transition metal catalyst,
ii) ethylenically unsaturated hydrocarbon and a transition metal catalyst,
iii) a polymer having a polymeric backbone, cyclic olefinic pendent group, and linking group linking the olefinic pendent group to the polymeric backbone,
iv) a copolymer of ethylene and a strained, cyclic alkylene,
v) ethylene/vinyl aralkyl copolymer,
vi) ascorbate,
vii) isoascorbate,
viii) sulfite,
ix) ascorbate and a transition metal catalyst, the catalyst comprising a simple metal or salt, or a compound, complex or chelate of the transition metal,
x) a transition metal complex or chelate of a polycarboxylic acid, salicylic acid, or polyamine,
xi) a tannin, and
xii) reduced metal.

15. The multilayer film of claim 12 wherein the polymeric adhesive of the third and seventh layers comprises a material selected from the group consisting of:
i) ethylene/vinyl acetate copolymer;
ii) anhydride grafted ethylene/vinyl acetate copolymer;
iii) anhydride grafted ethylene/alpha olefin copolymer; and
iv) anhydride grafted low density polyethylene.

16. A laminate comprising:
a) a multilayer film comprising:
i) a first layer comprising a blend of:
(a) a polymer, and
(b) an antifog agent;
ii) a second layer comprising an oxygen scavenger; and
iii) a third layer comprising a polymer, and
b) a second film comprising a material selected from the group consisting of
i) polyethylene terephthalate,
ii) biaxially oriented nylon,
iii) biaxially oriented polypropylene,
iv) polyvinyl chloride, and
v) polyvinylidene dichloride,
the second film bonded to the third layer of the multilayer film;
wherein the antifog agent comprises a material selected from the group consisting of:
i) mono fatty acid derivative of glycerol, and
ii) a polyglycerol mono fatty acid derivative; and
wherein the first outer layer comprises from 0.1% to 3%, by weight of the first outer layer, of the antifog agent.

17. The multilayer film of claim 16 wherein the polymer of the first and third layers comprises a material selected from the group consisting of:
a) ethylene/alpha olefin copolymer;
b) ethylene/vinyl acetate copolymer;
c) ionomer resin;
d) ethylene/acrylic or methacrylic acid copolymer;
e) ethylene/acrylate or methacrylate copolymer; and
f) low density polyethylene.

18. The multilayer film of claim 16 wherein the oxygen scavenger of the second layer comprises a material selected from the group consisting of:
i) oxidizable organic compound and a transition metal catalyst,
ii) ethylenically unsaturated hydrocarbon and a transition metal catalyst,
iii) a polymer having a polymeric backbone, cyclic olefinic pendent group, and linking group linking the olefinic pendent group to the polymeric backbone,
iv) a copolymer of ethylene and a strained, cyclic alkylene,
v) ethylene/vinyl aralkyl copolymer,
vi) ascorbate,
vii) isoascorbate,
viii) sulfite,
ix) ascorbate and a transition metal catalyst, the catalyst comprising a simple metal or salt, or a compound, complex or chelate of the transition metal,
x) a transition metal complex or chelate of a polycarboxylic acid, salicylic acid, or polyamine,
xi) a tannin, and
xii) reduced metal.

19. The film of claim 16 comprising an oxygen barrier layer, disposed between the internal layer comprising the oxygen scavenger, and one of the first and second outer layers, the oxygen barrier layer having an oxygen transmission rate of no more than 100 cc/m²/24 hr at 25° C., 0% RH, 1 atm (ASTM D 3985).

20. A multilayer film comprising:
a) a first layer comprising a blend of:
i) a polymer, and
ii) an antifog agent;
b) a second layer comprising an oxygen scavenger;
c) a third layer comprising a polymeric adhesive;
d) a fourth layer comprising an oxygen barrier;
e) a fifth layer comprising a polymeric adhesive; and
f) a sixth layer comprising a polymer;
wherein the antifog agent comprises a material selected from the group consisting of:
i) a mono fatty acid derivative of glycerol, and
ii) a polyglycerol mono fatty acid derivative; and
wherein the first outer layer comprises from 0.1% to 3%, by weight of the first outer layer, of the antifog agent.
